(19) United States
(12) Patent Application Publication
(10) Pub. No.: US 2017/0142928 A1
(43) Pub. Date: May 25, 2017

(54) ANIMAL FEEDER DEVICE

(71) Applicant: Stephen Vincent Rust, Ringwood, NJ (US)

(72) Inventor: Stephen Vincent Rust, Ringwood, NJ (US)

(21) Appl. No.: 15/358,812

(22) Filed: Nov. 22, 2016

Related U.S. Application Data
(60) Provisional application No. 62/259,920, filed on Nov. 25, 2015.

(51) Int. Cl. A01K 5/00

(52) U.S. Cl. CPC A01K 5/008

(57) ABSTRACT

An animal feeder device is provided. The animal feeder device provides a net integrated with an expandable frame along a peripheral opening of the net. The frame selectively moves between a retracted condition and an extended condition effectively holding the net open, making it easy for one person to fit feed therein, and wherein the retracted condition can make the peripheral opening selectively small enough to prevent the feeding animal from reaching into the opening of the net.

### CROSS-REFERENCE TO RELATED APPLICATION

This application claims the benefit of priority of U.S. provisional application No. 62/259,920, filed 25-Nov.-2015, the contents of which are herein incorporated by reference.

### BACKGROUND OF THE INVENTION

The present invention relates to animal husbandry and, more particularly, to an animal feeder device providing a hay feeder net incorporating an expandable frame along a periphery of the net for selectively adjusting of the net opening.

Existing slow-feed hay nets used to feed horses and other livestock are difficult to fill with hay. This is because the opening of the net for receiving the feed needs to be held open by another person or by hooks during filling. With no current integrated method for keeping the opening in an open condition, filling feed hay nets is a time consuming and inconvenient process. Furthermore, hooks for hanging the net on during filling are cumbersome and make the nets difficult to remove from the hooks once they are filled with hay.

In short, existing hay nets take a long time to fill, require additional labor or separate hanging devices to manage the filling process, and typically result in waste as hay falls outside of the net instead of into the net.

As can be seen, there is a need for a hay feeder net incorporating an expandable frame along a periphery of the net, wherein the frame moves between a retracted condition and an extended condition effectively holding the net open, making it easy to fill by one person to fit feed therein, and wherein the retracted condition can select a small enough opening to prevent the feeding animal from reaching into the opening of the net.

### SUMMARY OF THE INVENTION

In one aspect of the present invention, a hay feeder net incorporating an expandable frame includes a netting having a periphery defining an opening; and a rigid frame integrated along the periphery, wherein the rigid frame is selectively movable between an extended condition and a retracted condition decreasing the opening.

In another aspect of the present invention, the hay feeder net incorporating an expandable frame includes a netting having a plurality of rows of net holes terminating at a periphery defining an opening; a rigid frame woven along a penultimate row of the plurality of rows of net holes, wherein the rigid frame includes a plurality of telescoping members interconnected by a plurality of connectors so as to be selectively movable between an extended condition and a retracted condition decreasing the opening, and wherein at least one connector of the plurality of connectors is flexible for allowing one side of the rigid frame to be opened independently from an opposing side of the frame; a rope woven along a terminus row of the plurality of rows of net holes adjacent the opening; and a plurality of feed received through the opening, wherein the plurality of feed is dimensioned and adapted to not fall out through the plurality of net holes.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of a frame of the present invention in an extended condition;

FIG. 3 is a perspective view of an exemplary embodiment of the frame of the present invention in a retracted condition;

FIG. 4 is a perspective view of an exemplary embodiment of the frame of the present invention;

FIG. 5 is an exploded detailed perspective view of an exemplary embodiment of the present invention;

FIG. 6 is a top view of an exemplary embodiment of the frame of the present invention in the extended condition;

FIG. 7 is a top view of an exemplary embodiment of the frame of the present invention in the extended condition; and

FIG. 8 is a top view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an animal feeder device providing a net integrated with an expandable frame along a peripheral opening of the net. The frame selectively moves between a retracted condition and an extended condition effectively holding the net open, making it easy for one person to fit feed therein, and wherein the retracted condition can make the peripheral opening selectively small enough to prevent the feeding animal from reaching into the opening of the net.

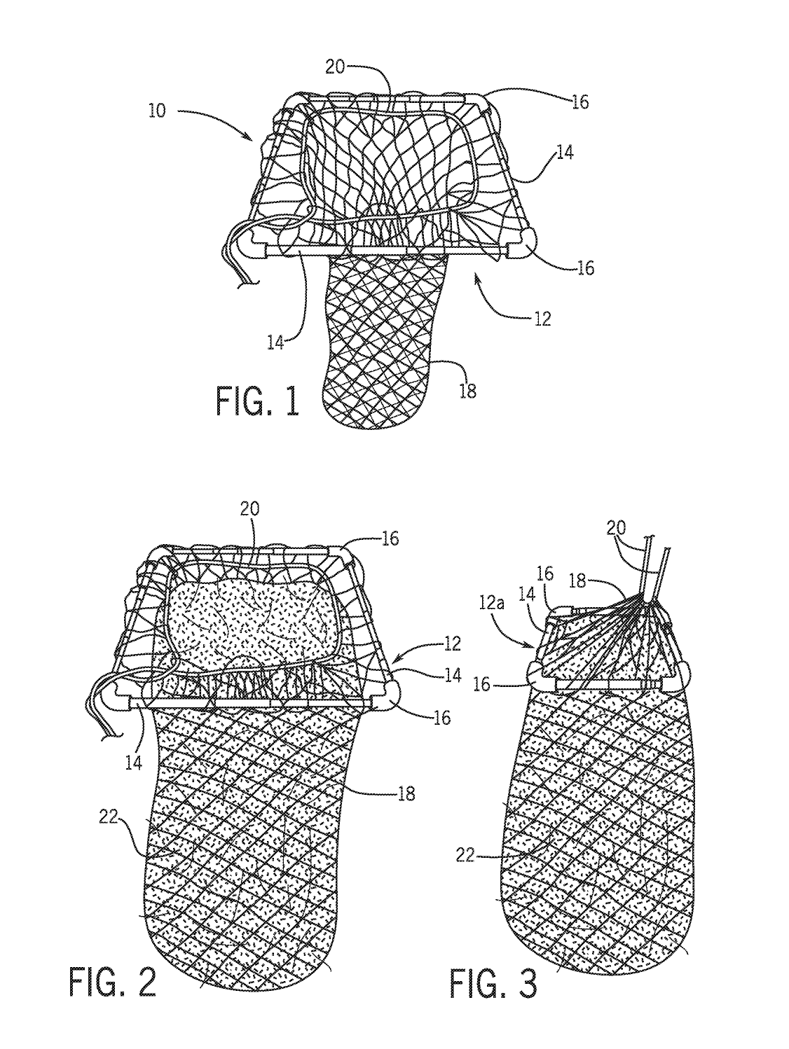

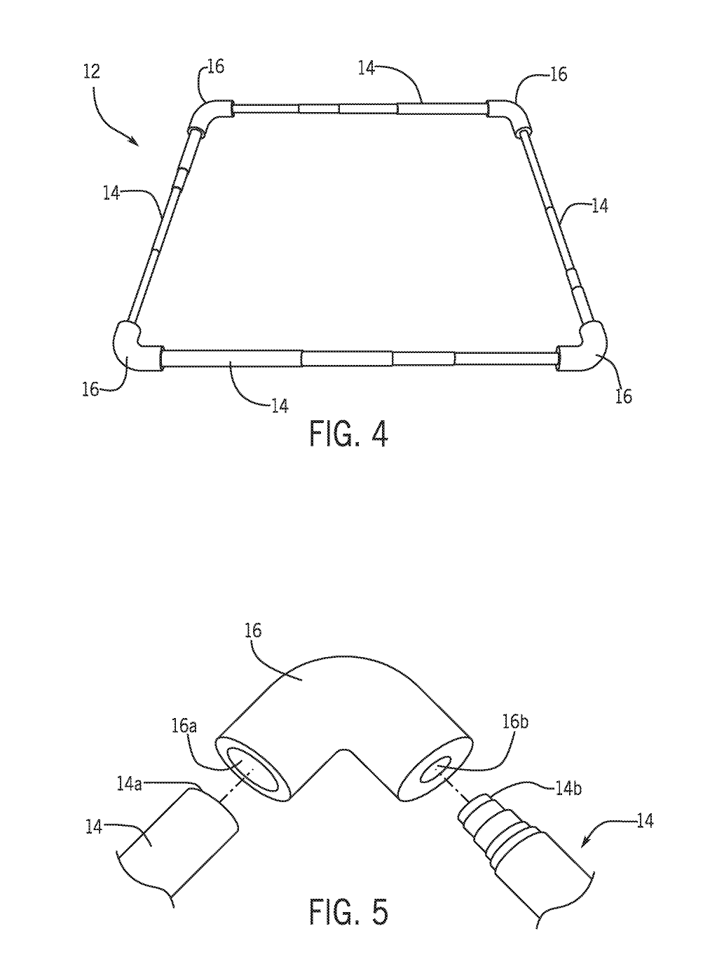

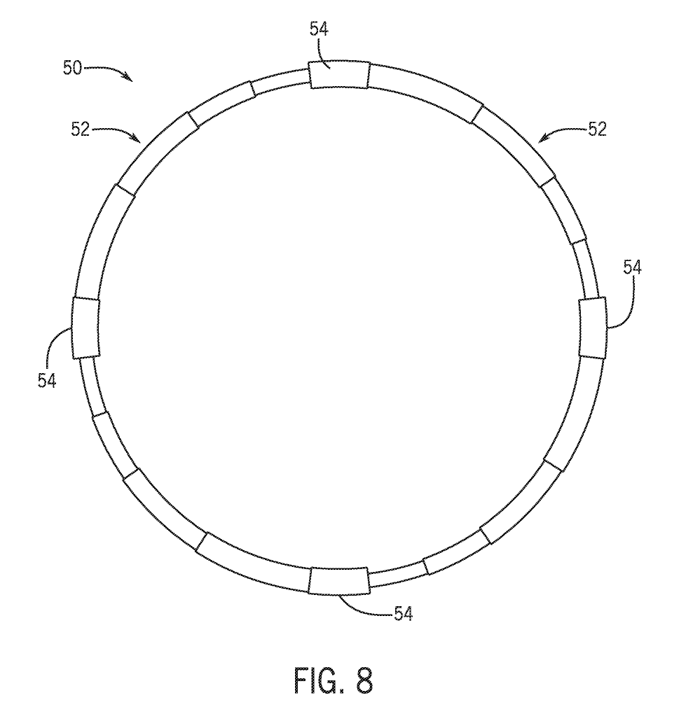

Referring to FIGS. 1 through 8, the present invention may include an animal feeder device 10 incorporating an expandable frame 12, 30, 40 or 50 along or adjacent to a periphery of its netting 18. The netting 18 may be selected for the desired opening size and holding capacity, wherein the netting material should be strong enough to prevent a horse or other animal from chewing through. The netting 18 typically provides rows of net holes, as illustrated in FIGS. 1-3.

The expandable frame 12, 30, 40, 50, may include a plurality of telescoping members 14, 32, 42, or 52 interconnected by connectors 16, 34, 44, or 54. Each telescoping member 14, 32, 42, or 52 may be a series of hollow tubes 15 dimensioned and adapted to nest inside one another, such that a smaller tube 15 can be sequentially extended out of or retracted into an adjacent larger tube 15 so as to move between an extended condition and a retracted condition 12a, as illustrated in FIGS. 2 and 3, respectively. Each connector 16, 34, 44, or 54 may provide an opposing large opening 16a and small opening 16b for slidably receiving the largest end 14a and the smallest end 14b, respectively, of the tubes 15 of the telescoping members 14, 32, 42, or 52.

In certain embodiments, the connector 16, 34, 44, or 54 can vary in design; they can be a hollow elbow that fits over the outside diameter of its telescoping member 14, 32, 42, or 52, they can be a solid elbow that fits into the open end of each telescoping member 14, 32, 42, or 52, or they can be an angled clamp. The connector 16, 34, 44, or 54 can be rigid or they can flex to allow the frame 12 to be opened non-uniformly. That is, hinged or connectors 16, 34, 44, or 54 can allow one side of the frame 12 to be opened independently from the opposing side of the frame 12.

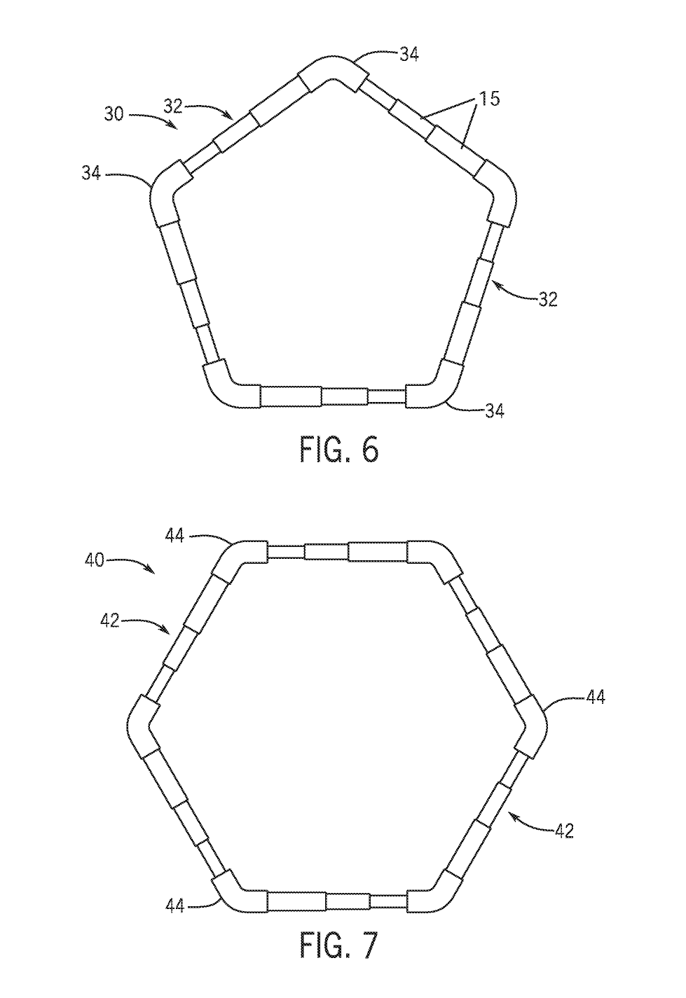

The telescoping members 14, 32, 42, or 52 may be made of sufficiently rigid material that can be repeatedly bent without fracturing, such as aluminum, steel, plastic, stainless steel, carbon fiber, fiberglass, and the like. The number of tubes 15 and thus the length of each telescoping member 14, 32, 42, or 52 may be determined based upon the desired shape and size of the opening/periphery of the netting 18. The telescoping members 14, 32, 42, or 52 can have a curvature instead of being straight to make the frame 12 more circular or other shapes instead of polygonal, as illustrated in FIGS. 6-8.

Each telescoping member 14, 32, 42, or 52 may be woven through a row of net holes of the netting 18. Most commonly this would be the second row of net holes from the periphery of the netting 18, the periphery defining the net opening. The weaving may be done such that each telescoping member 14, 32, 42, or 52 passes through approximately the same number of net holes. Once the telescoping member 14, 32, 42, or 52 are in place, the end 14a or 14b of one telescoping member 14, 32, 42, or 52 will be attached to the suitable end 16a or 16b of the adjacent connector 16, 34, 44, or 54. This is continued until all of the telescoping member 14, 32, 42, or 52 are connected to one another to create the frame 12 along or adjacent to the periphery of the netting 18. Alternatively, the frame 12 can be constructed leaving a gap between telescoping members and connectors, and then weaving that frame 12 through the net holes of the netting 18.

This effectively creates a netting 18 integrated with the frame 12 that can be positioned between the extended condition rigidly holding the netting 18 open during filling and the retracted condition to a smaller size after the netting 18 is sufficiently filled with feed 22. Thereby, the animal feeder device 10 may selectively define the opening (i.e., the periphery) of the netting 18, whereby the adjustable opening size of the netting 18 controls the speed at which an animal can feed from the netting 18. That is, larger openings allow the animal to obtain feed 20 faster than smaller openings do.

Once the frame 12 is in place, a rope 20 may be woven through the top row of net holes of the netting 18. The rope 20 may be attached to itself at the ends to create a loop. A spring-loaded clasp may be used to attach this rope to a suitable overhead structure. The assembly can be made without the hanging rope 20 if it is desirable to lay the animal feeder device 10 directly on the ground after filling.

The feed 22 can be any appropriate size and consistency to fit in the netting 18 without falling through the net holes yet allow the animals to grasp and remove it for eating through the net holes. In certain embodiments, eyelets can be incorporated into the frame 12 for attachments to hold the netting 18 in a desired position and/or extended condition.

A user of the present invention can selectively adjust the periphery of the netting 18 for filling the netting 18 with feed 22 or for allowing the animals to feed therefrom so as to minimize waste and inconvenience found in standard feed nets. Feed 22, such as hay or the like and be in the form of flakes, bales, or in loose strands, wherein the feed 22 may be inserted into the netting 18 when the frame 12 is in the extended condition. The frame could then be moved to the retracted condition 12a, in certain embodiments by cinching the rope 20 also woven along said periphery, to a smaller size keeping the peripheral opening of the netting 18 essentially inaccessible to the animal. The animal feeder device 10 then may be hung from above or laid on the floor to allow the animal to feed from it. Once the feed 22 is depleted, the frame 12 may be extended and the netting 18 can be refilled.

Additionally, this invention can be used wherever a net is required to have an opening in need of being held open in a rigid state and then closed to a smaller size via an integral expanding rigid frame, and thus the present invention can be used in other applications such as agriculture and fishing wherein holding items in a net is desirable.

It should be understood, of course, that the foregoing relates to exemplary embodiments of the invention and that modifications may be made without departing from the spirit and scope of the invention as set forth in the following claims.

What is claimed is:

1. A device, comprising:
a netting having a periphery defining an opening; and
a rigid frame integrated along the periphery, wherein the rigid frame is selectively movable between an extended condition and a retracted condition decreasing the opening.

2. The device of claim 1, wherein the rigid frame includes a plurality of telescoping members interconnected by a plurality of connectors.

3. The device of claim 1, wherein the netting further includes a plurality of rows of net holes, and wherein the rigid frame is woven along a second row of the plurality of rows of net holes from the opening.

4. The device of claim 3, further including a rope woven along a first row of the plurality of rows of net holes adjacent the opening.

5. The device of claim 1, wherein at least one connector of the plurality of connectors is flexible for allowing one side of the rigid frame to be opened independently from an opposing side of the frame.

6. The device of claim 1, further including feed received through the opening, wherein the feed is dimensioned and adapted to not fall out through the plurality of net holes.

7. A device, comprising:
a netting having a plurality of rows of net holes terminating at a periphery defining an opening;
a rigid frame woven along a penultimate row of the plurality of rows of net holes, wherein the rigid frame includes a plurality of telescoping members interconnected by a plurality of connectors so as to be selectively movable between an extended condition and a retracted condition decreasing the opening, and wherein at least one connector of the plurality of connectors is flexible for allowing one side of the rigid frame to be opened independently from an opposing side of the frame;
a rope woven along a terminus row of the plurality of rows of net holes adjacent the opening; and
a plurality of feed received through the opening, wherein the plurality of feed is dimensioned and adapted to not fall out through the plurality of net holes.
